(19) United States
(12) Patent Application Publication
(10) Pub. No.: US 2025/0115462 A1
(43) Pub. Date: Apr. 10, 2025

(54) DRIVING APPARATUS FOR A MOBILE CRANE

(71) Applicant: Liebherr-Werk Ehingen GmbH, Ehingen (DE)

(72) Inventors: Michael ENGST, Ehingen (DE); Nikolaus MUENCH, Mehrstetten (DE)

(21) Appl. No.: 18/894,894

(22) Filed: Sep. 24, 2024

(30) Foreign Application Priority Data
Oct. 6, 2023 (DE) 10 2023 127 276.4

(51) Int. Cl. B66C 9/14; B66C 13/12

(52) U.S. Cl. CPC B66C 9/14; B66C 13/12; B66C 2700/0357

(57) ABSTRACT

The disclosure relates to a driving apparatus for a mobile crane comprising an internal combustion engine, an electric machine, and a transfer case for selectively distributing power outputted to the transfer case to a driving mechanism, and to a pump arrangement for performing crane operation, wherein the internal combustion engine cooperates with an input shaft of the transfer case that cooperates with the driving mechanism, the electric machine cooperates with an intermediate shaft of the transfer case, and the pump arrangement cooperates with an output shaft of the transfer case. The driving apparatus comprises a first clutch arranged between the input and intermediate shafts for coupling them to each other or decoupling them from each other as required, and a second clutch arranged between the intermediate and output shafts for coupling them to each other or decoupling them from each other as required.

### CROSS REFERENCE TO RELATED APPLICATION

The present application claims priority to German Patent Application No. 10 2023 127 276.4 filed on Oct. 6, 2023. The entire contents of the above-listed application are hereby incorporated by reference for all purposes.

### TECHNICAL FIELD

The present disclosure relates to a driving apparatus for a mobile crane.

### BACKGROUND

What distinguishes a mobile crane from other types of cranes is that it has its own drive to move the crane, making it extremely flexible in terms of where it can be used. A typical mobile crane consists of a carrier vehicle and a crane mounted thereon. The carrier vehicle is usually either a type of lorry chassis or a specially designed vehicle chassis that is connected to the rotatably mounted crane via a slewing ring.

### SUMMARY

With the increasing electrification of drives, it is now possible to use an electric motor to drive mobile cranes in particular. For example, an electric motor is employed to actuate the requisite hydraulic pumps for crane operation, whereas the prior art continues to rely on an internal combustion engine to propel the mobile crane.

It is the object of the present disclosure to provide an improved hybrid driving apparatus for a mobile crane which requires as few components as possible and in this respect has a large number of desirable functions simultaneously.

This is achieved with the driving apparatus for a mobile crane, as described herein. Advantageous embodiments of the driving apparatus can also be found in this respect. Furthermore, the disclosure also comprises an advantageous method for operating such a driving apparatus, which has particular advantages with regard to a travel drive of the mobile crane or with regard to the reduction of emissions.

According to the disclosure, a driving apparatus for a mobile crane is provided, comprising an internal combustion engine, in particular a diesel engine, for outputting power, an electric machine for outputting power in its motor mode and/or for generating power in its generator mode, and a transfer case for selectively distributing power outputted to the transfer case to a driving mechanism for moving the mobile crane and to a pump arrangement for performing crane operation, wherein the internal combustion engine cooperates with an input shaft of the transfer case, the input shaft cooperates with the driving mechanism, the electric machine cooperates with an intermediate shaft of the transfer case, and the pump arrangement cooperates with an output shaft of the transfer case. The driving apparatus is characterized by a first clutch arranged between the input shaft and the intermediate shaft for coupling the input shaft and the intermediate shaft to each other or decoupling them from each other as required, and a second clutch arranged between the intermediate shaft and the output shaft for coupling the intermediate shaft and the output shaft to each other or decoupling them from each other as required.

An advantage of the driving apparatus according to the disclosure is that the transfer case has an output shaft which can be driven by both the internal combustion engine and the electric machine when the first clutch and the second clutch are in corresponding positions. For example, if it is desired to carry out crane operation purely electrically, the first clutch can be opened and the second clutch closed, so that the electric machine drives the intermediate shaft and also actuates the output shaft of the transfer case via the closed second clutch, so that crane operation (via the actuation of the pumps) is possible.

The transfer case is therefore configured to allow both the internal combustion engine and the electric machine to provide power to the transfer case. The transfer case can pass this power on to the driving mechanism and the pump arrangement. If the first clutch (K1) is open, the electric machine can therefore simultaneously supply the pump arrangement via the transfer case and the internal combustion engine can supply the driving mechanism for moving the mobile crane via the transfer case.

In this respect, the design of the driving apparatus for the mobile crane according to the disclosure is configured redundantly with regard to the drive of the output shaft, since in the event of a failure of the electric machine for driving the output shaft (which operates the crane with the aid of the hydraulic pumps), the internal combustion engine is also available as an alternative. Closing the first clutch and closing the second clutch creates a frictional connection between the input shaft and the output shaft of the transfer case so that the output shaft can also be driven using the internal combustion engine. This means that crane operation is also still possible if the electric machine is defective, so that the crane does not come to a standstill but can continue to operate.

A further advantage of the driving apparatus system according to the disclosure is that when the output shaft of the transfer case is driven with the aid of the internal combustion engine, the electric machine can also be operated in generator mode so that auxiliary consumers can be supplied with power.

A separate alternator, as is otherwise common in prior art implementations, can therefore be dispensed with.

According to the present disclosure, it can therefore be provided that the internal combustion engine is used to drive the input shaft of the transfer case. The internal combustion engine can be coupled to the input shaft in such a way that it drives the input shaft of the transfer case.

Furthermore, according to the disclosure, it may be provided that the electric machine is used to drive or be driven by the intermediate shaft of the transfer case. The electric machine can be coupled to the intermediate shaft in such a way that it drives the intermediate shaft of the transfer case.

According to a further advantageous modification, the output shaft of the transfer case is used for driving crane pumps, in particular hydraulic pumps, in order to convey a hydraulic fluid which is used to perform a crane function.

According to an advantageous modification of the present disclosure, it may be provided that the driving apparatus further comprises energy storage means connected to the electric machine for storing energy from the electric machine in generator mode or for supplying energy to the electric machine in motor mode. The energy storage is therefore used to accommodate the power generated by the electric machine or to feed the electric machine if it is operated in motor mode.

In addition, the power stored in the energy storage can also be used to supply energy to auxiliary consumers.

According to an optional embodiment of the present disclosure, it may also be provided that the energy storage can be charged by means of a charging port by an external energy source. When the electric machine is operated in the motor mode, the energy supplied via the charging connection can also be used to operate the electric machine in the motor mode, so that in such a state, charging of the energy storage device no longer occurs or only occurs at a slower rate.

According to an optional embodiment of the present disclosure, it may further be provided that the driving apparatus further comprises at least one auxiliary consumer, in particular a heating element for tempering a cabin and/or driver's cab of the mobile crane and/or a compressor of an air conditioning system for tempering a cabin of the mobile crane, and/or a heat pump for tempering an energy storage device and/or a heating element for tempering an energy storage device, wherein preferably the at least one auxiliary consumer for energy supply is connected to the electric machine in an intermediate circuit.

In this respect, it may be provided that the at least one auxiliary consumer is connected to the electric machine in such a way that the latter supplies the at least one auxiliary consumer with energy in a generator mode. For example, the at least one auxiliary consumer, preferably together with the energy storage device, can be arranged in an intermediate circuit, in particular a DC intermediate circuit, into which the energy generated by the electric machine is fed. A power supply with energy from the energy storage is also possible.

The advantage of the implementation according to the disclosure is that the electric machine is used to drive the hydraulic pumps during electric crane operation and can be used to supply power to the at least one auxiliary consumer during operation by means of the internal combustion engine, both during crane operation and also when the mobile crane is moving. This means that only one electric machine is required, so that the 24V alternator usually coupled to the internal combustion engine can be omitted. In electric crane operation, the electric machine acts as a motor to drive the crane components, whereas when driving by means of the internal combustion engine for travel and/or crane operation, the electric machine is used as a generator.

Conventional heaters use the waste heat from the internal combustion engine or rely on a fuel-powered auxiliary heater. According to the disclosure, however, it can be provided that a heating unit or a compressor of a cooling circuit is operated with energy from the intermediate circuit or the electric machine or the energy storage unit, so that air conditioning can also be carried out independently of the operation of the internal combustion engine or the consumption of a fuel.

According to a further optional embodiment of the present disclosure, it may be provided that the intermediate circuit has a connection possibility to an external power supply. The connection possibility to the external power supply enables not only the charging of the energy storage, but furthermore also the continuous operation of the electric machine in a motor mode for crane operation. For example, when using a mobile crane, it may be desirable to operate it without using the internal combustion engine after the crane has been moved to its place of work so that exhaust and noise emissions do not occur. For this purpose, an external power supply can then be connected so that the energy required to operate the crane is drawn from it.

According to a further advantageous embodiment of the present disclosure, it may be provided that the intermediate circuit is connected to the electric machine via at least one contactor and/or an inverter. This allows the electric machine to be disconnected from the inverter and the intermediate circuit, which is advantageous, for example, if the inverter fails during driving operation.

Furthermore, according to the disclosure, it may be provided that an onboard network, in particular a 12 V or 24 V onboard network, is connected to the intermediate circuit via a DC/DC converter.

According to the disclosure, it may further be provided that the intermediate circuit has a voltage level which is greater than 48 V, preferably at least 200 V, preferably at least 500 V and most preferably at least 700 V.

According to the disclosure, it may further be provided that the driving apparatus further comprises a manual transmission for shifting different gears, which is arranged between the input shaft of the transfer case and an engine output shaft of the internal combustion engine, wherein the output of the manual transmission cooperates with or is the input shaft of the transfer case.

To move the mobile crane, it is advantageous if the internal combustion engine can supply different ratios to the input shaft of the transfer case via a manual transmission. The driving apparatus according to the disclosure enables the traction interruption occurring in this respect to be reduced during the shifting of the various gears of the manual transmission by closing the first clutch. This allows the electric machine attached to the intermediate shaft to operate temporarily in motor mode so that there is no complete loss of tractive force during a gear change. Driving without or with less traction interruption is more pleasant for the mobile crane driver and results in an improved driving experience.

According to an optional embodiment of the present disclosure, it may be provided that the electric machine is a high-voltage electric motor. Preferably, a high-voltage electric motor has an output voltage of at least 400 V.

According to an optional modification of the present disclosure, it may be provided that when the first clutch is closed and the second clutch is open, the transfer case is configured to supply power from the internal combustion engine to the driving mechanism (e.g. wheel axle) which is usable for moving the mobile crane. To transmit the power input to the input shaft by the internal combustion engine to the driving mechanism, for example a driving axle connected to wheels or the like, a third clutch can also be provided, which optionally creates or releases a force fit connection between the input shaft and the driving mechanism, in particular a driving axle. In this respect, this third clutch can also be arranged in the transfer case.

Furthermore, according to an advantageous modification, it may be provided that when the first clutch is closed and the second clutch is open, the transfer case is configured to establish a force fit connection with the electric machine, so that the electric machine can generate power in a generator mode or support the power of the internal combustion engine in a motor mode. In this respect, it is also possible for the electric machine to be solely responsible for driving the mobile crane in its motor mode, i.e. to ensure the move of the mobile crane without the support of the internal combustion engine.

According to a further embodiment of the present disclosure, it may be provided that when the second clutch is closed, the transfer case is configured to decouple the driving mechanism from the input shaft by means of a third clutch in order to enable crane operation to be carried out only when the mobile crane is stationary.

The disclosure further relates to a mobile crane with a driving apparatus according to one of the foregoing aspects, optionally wherein the mobile crane is a large mobile crane with a lifting moment of at least 400 kNm.

The disclosure also relates to a method of operating a driving apparatus according to one of the aspects discussed or a mobile crane according to the foregoing aspect.

In this respect, it may also be provided that the electric machine is operated during a shift operation in the manual transmission in order to reduce the traction interruption caused by the shift operation.

So during a gear change of the manual transmission to change the ratio of the internal combustion engine with which the internal combustion engine drives the input shaft of the transfer case, a force for driving the travel drive is supplied by the electric machine so that the traction interruption occurring during a gear change is mitigated or even completely eliminated.

Furthermore, according to the disclosure, it can be provided that in an idling phase of a crane operation, the internal combustion engine is nevertheless loaded by a generator mode of the electric machine in order to maintain the exhaust gas temperature at a predetermined level, for example in order to carry out exhaust gas aftertreatment with high efficiency and/or to switch off the internal combustion engine after a complete charging or when a desired charge state of the energy storage is reached and to continue the crane operation via the energy storage in order to end the noise or exhaust gas emissions generated during operation of the internal combustion engine. The internal combustion engine only starts up again once the charge level of the energy storage unit falls below a predetermined level.

### BRIEF DESCRIPTION OF THE FIGURES

Further features, details and advantages of the disclosure will become apparent from the following description of the figures. There are shown:

FIG. 1: a side view of a mobile crane;

FIG. 2: a schematic representation of a driving apparatus for a mobile crane according to the prior art;

FIG. 3: a driving apparatus for a crane according to the present disclosure; and

FIG. 4: a schematic representation of the connection of the electric machine 22 in the driving apparatus according to the disclosure.

### DETAILED DESCRIPTION

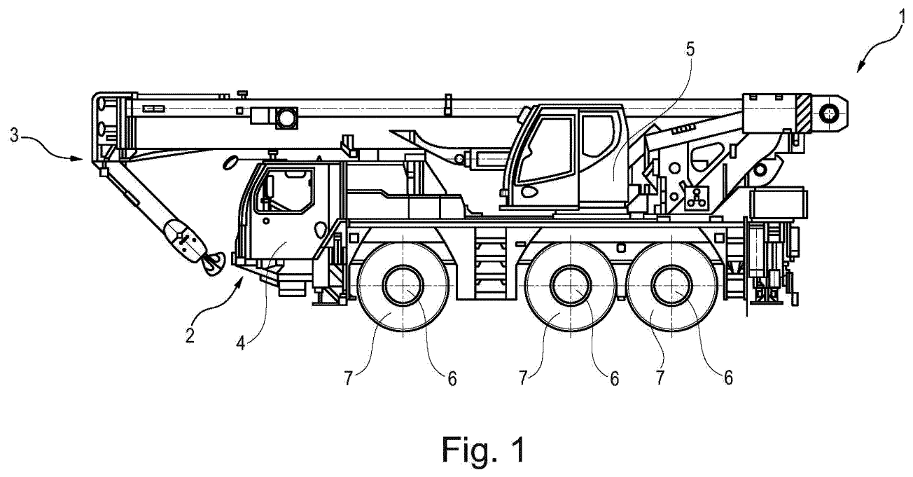

FIG. 1 shows a side view of a mobile crane.

The mobile crane 1 has an undercarriage 2 and a superstructure 3. The undercarriage 2 has a driver's cab 4 and the superstructure 3 has a cabin 5. The undercarriage 2 has driving axles 6 with wheels 7. The crane 1 has a jib (also said crane arm), which can be extended and is rotatably hinged relative to the undercarriage.

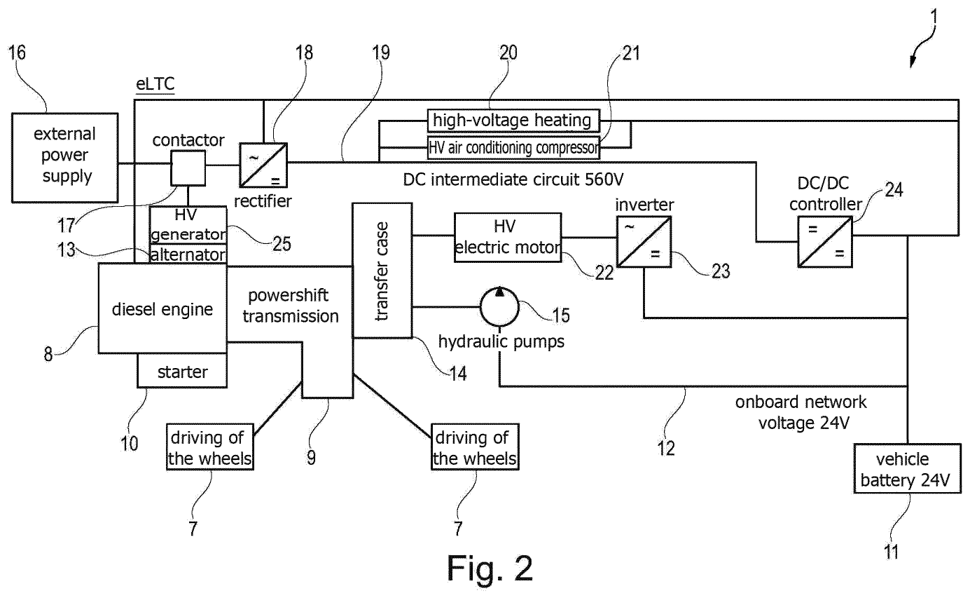

FIG. 2 shows a schematic representation of a driving apparatus for a mobile crane 1, as is known from the prior art.

An internal combustion engine 8 arranged in the undercarriage 2, in particular a diesel engine, drives the driving axles 6 and thus the wheels 7 via the powershift transmission 9. The internal combustion engine 8 is started via the starter 10. The starter 10 receives its energy from the vehicle battery 11 with a typical voltage of 12 V or 24 V (connection not shown) via the onboard network 12. The alternator 13 is driven by the internal combustion engine 8, feeds the onboard network 12 and charges the vehicle battery 11. Diese Konfiguration stellt ein bekanntes System in einem Fahrzeug dar.

The onboard network 12 supplies energy to all crane components in relation to their control systems. This means that the power required by most of the components does not have to be provided by the vehicle battery 11, but the energy required for this comes from the internal combustion engine 8. The vehicle battery only provides the energy required for the electronic control of the components.

A clutch (not shown) is provided between the powershift transmission 9 and the transfer case 14, which ensures that energy is not transferred to the transfer case 14 during travel so that the crane boom cannot move while the mobile crane is in motion.

During crane operation, the internal combustion engine 8 drives the components for the crane work (and consequently also the at least one hydraulic pump 15). According to the diagram shown, the power flow is effected via the powershift transmission 9 and the transfer case 14 via a mechanical connection to the at least one hydraulic pump 15. The hydraulic lines to the crane actuators are not shown. The at least one hydraulic pump 15 obtains the electric power required for its control via the onboard network 12 and can be implemented by different types of pumps, e.g. by a swivel pump.

If emission-free operation is now desired, the mobile crane 1 can also use an external power supply 16 as the primary energy source. As a rule, this external power supply 16 can be connected to the mobile crane 1 via a plug connection. The rectifier 18 then provides a DC intermediate circuit 19 via contactors 17. All crane components with a high energy requirement are connected to this DC intermediate circuit 19. The DC intermediate circuit 19 is present, for example, in the undercarriage 2 and in the superstructure 3. It is carried through the slewing ring between the undercarriage 2 and the superstructure 3.

Cabin 5 is temperature-controlled via a high-voltage heating system 20 and a high-voltage air conditioning compressor 21. In the prior art, the components are electrically controlled via the onboard network 12. The high-voltage electric motor 22 is connected to the DC intermediate circuit 19 via an inverter 23 and supplied with power. Since the powershift transmission 9 is separated from the transfer case 14 in emission-free crane operation, no energy takes an undesired path into the powershift transmission, so that all energy from the high-voltage electric motor 22 goes into the hydraulic pumps 15 via mechanical connections and the transfer case 14. The internal combustion engine 8 is inactive in this operating state (emission-free operation) and is therefore unable to drive the alternator 13 so that it cannot supply the onboard network 12. This task is performed by the DC/DC controller 24, which converts the energy supplied by the external power supply so that the onboard network is supplied with the appropriate voltage.

Without such a supplying of the onboard network via the external energy source, the relatively small vehicle battery 11 would be quickly discharged, as the power requirement of the onboard network is quite high and is around 1 kW.

The disadvantage of this is that with such a configuration, no DC intermediate circuit 19 is possible when operating the crane by means of the internal combustion engine 8, which supplies energy to a high-voltage heating system or an HV air conditioning compressor, for example. This explicitly requires a generator 25 which, unlike the alternator that is already present, must generate a voltage in a high-voltage range. If it is now desired during crane operation by means of internal combustion engine 8 that the cabin 5 is also heated via the high-voltage heater 20 and the high-voltage air conditioning compressor 21, an additional high-voltage generator 25 must also be provided on the internal combustion engine 8 (as shown in FIG. 1) in order to supply these auxiliary consumers with energy. This also goes via the contactors 17 to the rectifier 18 and is powerful enough to cover the (relatively low) energy requirement in the DC intermediate circuit 19. The high-voltage electric motor 22 is, after all, decoupled and out of operation during crane operation by means of the internal combustion engine.

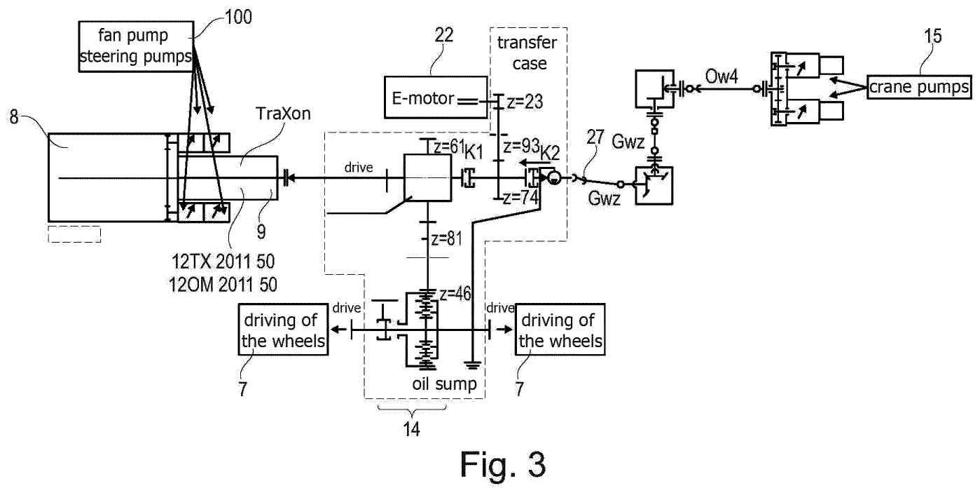

FIG. 3 shows a driving apparatus for a crane according to the present disclosure.

In contrast to the prior art, the electric machine 22 is integrated into the transfer case 14 of the driving apparatus of the mobile crane 1 in a very specific way. The internal combustion engine 8, which is implemented by a diesel engine, and the manual transmission 9 attached thereto can be detected. In this respect, the output shaft of the manual transmission 9 acts on the input shaft of the transfer case 14 via which the wheel drive 7 of the mobile crane can be driven. In this respect, the input shaft can be coupled to an intermediate shaft via a first clutch K1, to which the electric machine 22 is connected. The intermediate shaft can in turn be coupled to the output shaft of the transfer case 14 via a second clutch K2. The at least one pump required for crane operation is operated via the output shaft.

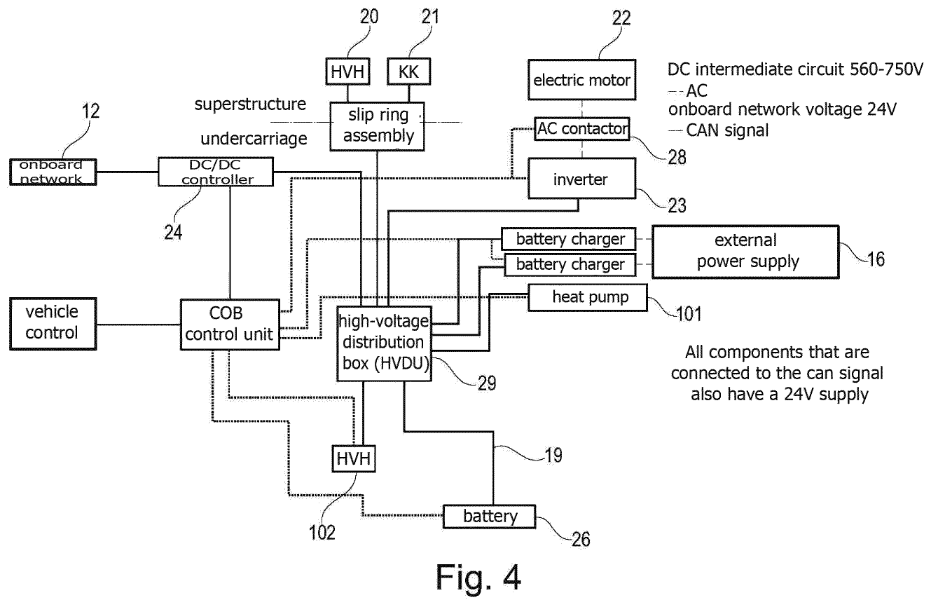

In this respect, FIG. 4 shows which components are connected to the electric machine 22 according to the disclosure.

In this respect, the electric machine 22 is connected via a contactor 28 and an inverter 23 to a DC intermediate circuit 19, to which several auxiliary consumers are connected and draw their energy.

An energy storage 26 can be detected, which is configured to store the energy generated by the electric machine 22 when the electric machine 22 is operated in a generator mode. Alternatively, the energy stored in the energy storage 26 is used for driving the electric machine 22 in a motor mode.

It can also be detected that a high-voltage air conditioning compressor 21 and a heater 20 are provided for tempering the cabin of the mobile crane and also draw their energy from the intermediate circuit 19.

The onboard network 12, which typically operates at 12 V or 24 V, is also connected to the intermediate circuit 19 via a DC/DC controller 24. A heat pump 101 and a further heating element 102 may also be provided and used for tempering the energy storage 26. It is known to those skilled in the art that large-volume energy storage devices are sensitive to their temperature, so that it is advantageous to keep them in a favorable temperature range for improved performance and the longest possible service life. This applies in particular during charging of the energy storage unit, as energy storage can only take place at high speed and gently for the battery 26 in a corresponding temperature window.

In addition, an external power supply 16 can also be detected, which can charge the energy storage 26 via at least one rechargeable battery charger. Alternatively, however, it is also possible for the energy originating from the external power supply 16 to be used directly for driving the electric machine 22. For controlling the energy flows in the intermediate circuit 19, an optional distribution box 29 can be provided, which contains fuses and corresponding connections. At least one contactor can also be provided in such an optional distribution box 29 in order to be able to establish a connection to the rechargeable battery chargers. Each device can connect to the DC intermediate circuit 19 and draw power from the DC intermediate circuit 19. The optional distributor box 29 does not intervene here.

As can be seen from the combined view of FIG. 3 and FIG. 4, the electric machine 22 can be connected to the drive train of the internal combustion engine 8 by closing the clutch K1. When the mobile crane 1 is moving, the electric machine 22 can support the internal combustion engine 8 during travel or even provide complete propulsion for the mobile crane.

Furthermore, in a driving mode, it can be provided that the electric machine 22 is connected by means of the internal combustion engine via the first clutch K1 and acts as a generator. In this way, any auxiliary consumers (e.g. for battery air conditioning 101, 102, a high-voltage heater 20, a high-voltage air conditioning compressor 21) can be supplied and/or the energy storage in the form of a high-voltage air conditioning battery 26 can be charged. This takes place via the DC intermediate circuit 19, wherein the clutch K2 is naturally open in such a state.

Recuperation by the electric machine 22 is also possible in a driving mode by means of the internal combustion engine, so that the energy storage 26 is charged by the generator mode of the electric machine 22.

In crane operation, the clutch K2 is always closed, as this is the only way to transfer the corresponding energy to the at least one crane pump 15. By actuating the first clutch K1, the crane can be operated either by means of the internal combustion engine 8 (clutch K1 closed) or electrically (clutch K1 open).

If the first clutch K1 is closed, the crane is operated using the internal combustion engine 8 and the electric machine 22 acts as a generator. The energy generated in this respect by the electric machine 22 is used to supply the auxiliary consumers or to charge the energy storage 26. The advantage here is that no additional heating and no additional mechanical air conditioning compressor are required, as the respective components can be operated using the DC intermediate circuit 19 and the generator mode of the electric machine 22.

In crane operation, the cabin 5 is always air-conditioned (by means of high-voltage heater 20 and high-voltage air conditioning compressor 21) via high-voltage components, regardless of whether it is operated using the internal combustion engine or the electric machine 22. This has the advantage that air conditioning is also possible when the output shaft 27 is stationary and fuel combustion is not desired.

In electric crane operation, i.e. when the internal combustion engine 8 is inactive, the energy for the auxiliary consumers comes either from the energy storage 26 or from the external power supply 16.

The advantage here is that the high-voltage air conditioning compressor 21 and the high-voltage heater 20 can also air-condition the cabin 5 when the total drive train (engine, transmission, shafts) is at a standstill and, in addition, no pollutant emissions are produced when operating a high-voltage air conditioning compressor 20 in comparison to a fuel-powered parking heater.

An advantageous method for operating a driving apparatus is that idling phases in crane operation, in which no crane actuation takes place, can be used to continue to load the internal combustion engine 8 in order to keep the exhaust gas temperature above a certain temperature threshold. This improves exhaust gas aftertreatment and leads to lower emissions overall. If the energy storage unit 26 is full or has exceeded a certain charge level, the internal combustion engine 8 can be switched off and crane operation can be continued using the electric machine 22 in conjunction with the energy storage unit. Stopping the internal combustion engine 8 also stops noise emissions emitted by the internal combustion engine, so that less idling operation of the internal combustion engine 8 occurs.

In addition, the driving apparatus can advantageously be used to mitigate or completely eliminate the traction interruption of a manual transmission of the internal combustion engine that occurs during gear shifting. The flow of power from the internal combustion engine 8 to the wheels 7 must be briefly interrupted in order to shift gears, wherein the application of a corresponding force by the electric machine 22 in motor mode mitigates the traction interruption.

Another advantage is that the crane also retains full functionality in the event of a fault in the high-voltage system, as operation is still possible using the internal combustion engine and the corresponding mechanical shafts (when the first clutch K1 and the second clutch K2 are closed) if the electric machine 22 fails. This is not necessarily the case when using a high-voltage electric motor on the diesel engine and an electric motor for driving the hydraulic pump, as the internal combustion engine 8 then no longer needs to have a mechanical connection to the hydraulic pump.

### LIST OF REFERENCE SIGNS

mobile crane 1
undercarriage 2
superstructure 3
driver's cab 4
cabin 5
driving axles 6
wheels 7
internal combustion engine 8
powershift transmission 9
starter 10
vehicle battery 11
onboard network 12
alternator 13
transfer case 14
hydraulic pumps 15
external power supply 16
contactor 17
rectifier 18
DC intermediate circuit 19
high-voltage heating 20
high-voltage air conditioning compressor 21
high-voltage electric motor 22
inverter 23
DC/DC controller 24
high-voltage generator 25
high-voltage battery 26
shaft 27
AC contactor 28
high-voltage distribution box 29
clutch K1
clutch K2
steering pump 100
heat pump 101
high-voltage heating 102

1. A driving apparatus for a mobile crane, comprising:
an internal combustion engine for outputting power,
an electric machine for outputting power in its motor mode and/or for generating power in its generator mode, and
a transfer case for selectively distributing a power output to the transfer case to a drive mechanism for moving the mobile crane and to a pump arrangement for performing a crane operation, wherein
the internal combustion engine cooperates with an input shaft of the transfer case,
the input shaft cooperates with the driving mechanism,
the electric machine cooperates with an intermediate shaft of the transfer case, and
the pump arrangement cooperates with an output shaft of the transfer case,
wherein
a first clutch arranged between the input shaft and the intermediate shaft, for coupling the input shaft and the intermediate shaft to each other or decoupling them from each other as required, and
a second clutch arranged between the intermediate shaft and the output shaft for coupling the intermediate shaft and the output shaft to each other or decoupling them from each other as required.

2. The driving apparatus according to claim 1, further comprising an energy storage connected to the electric machine for storing energy from the electric machine in the generator mode or supplying energy to the electric machine in the motor mode.

3. The driving apparatus according to claim 1, further comprising at least one auxiliary consumer, wherein the at least one auxiliary consumer for energy supply is connected to the electric machine in an intermediate circuit.

4. The driving apparatus according to claim 3, wherein the intermediate circuit has a connection possibility to an external power supply.

5. The driving apparatus according to claim 3, wherein the intermediate circuit is connected to the electric machine via at least one contactor and/or an inverter.

6. The driving apparatus according to claim 3, wherein an onboard network is connected to the intermediate circuit via a DC/DC converter.

7. The driving apparatus according to claim 1, further comprising a manual transmission for shifting different gears, which is arranged between the input shaft of the transfer case and an engine output shaft of the internal combustion engine, wherein the output of the manual transmission cooperates with or is the input shaft of the transfer case.

8. The driving apparatus according to claim 1, wherein the electric machine is a high-voltage electric motor.

9. The driving apparatus according to claim 1, wherein, when the first clutch is closed and the second clutch is open, the transfer case is configured to supply power of the internal combustion engine to the driving mechanism which is usable to move the mobile crane.

10. The driving apparatus according to claim 9, wherein, when the first clutch is closed and the second clutch is open, the transfer case is configured to effect a force fit connection with the electric machine, so that the electric machine can generate power in a generator mode or support the output of the internal combustion engine in a motor mode.

11. The driving apparatus according to claim 1, wherein when the second clutch is closed, the transfer case is configured to decouple the driving mechanism from the input shaft by means of a third clutch to ensure that crane operation is only possible when the mobile crane is stationary.

12. A mobile crane with a driving apparatus according to claim 1, wherein the mobile crane is a mobile crane with a lifting moment of at least 400 kNm.

13. A method of operating a driving apparatus according to claim 1.

14. The method according to claim 13, wherein the driving apparatus further comprises a manual transmission for shifting different gears, which is arranged between the input shaft of the transfer case and an engine output shaft of the internal combustion engine, wherein the output of the manual transmission cooperates with or is the input shaft of the transfer case, wherein a motor mode of the electric machine is carried out during a shift operation in the manual transmission in order to reduce a traction interruption caused by the shift operation.

15. The method according to claim 12 wherein, in an idling phase of a crane operation, the internal combustion engine is nevertheless loaded by a generator mode of the electric machine in order to maintain the exhaust gas temperature at a predetermined level.

16. The method according to claim 15, wherein he loading of the internal combustion engine includes carrying out exhaust gas aftertreatment with increased efficiency, the method further comprising switching off the internal combustion engine after a complete charging or when a desired charge state of an energy storage is reached and to continue operation via the energy storage in order to end noise or exhaust gas emissions generated during operation of the internal combustion engine.

17. The driving apparatus according to claim 1, further comprising at least one auxiliary consumer, the auxiliary consumer being a heating element for tempering a cabin and/or driver's cab of the mobile crane and/or a compressor of an air conditioning system for tempering a cabin of the mobile crane, and/or a heat pump for tempering an energy storage and/or a heating element for tempering an energy storage, wherein the at least one auxiliary consumer for energy supply is connected to the electric machine in an intermediate circuit.
